(19) United States
(12) Patent Application Publication
(10) Pub. No.: US 2009/0170530 A1
(43) Pub. Date: Jul. 2, 2009

(54) Device System and Method for Providing Availability Status and Alternate Contact Information Within a Wireless Keep-Quiet Zone

(75) Inventors: Jyothi C. Kadavallur, Bangalore (IN); Von A. Mock, Boynton Beach, FL (US)

Correspondence Address: Mayback & Hoffman, P.A., 5722 S. Flamingo Road, #232, Fort Lauderdale, FL, 33330, US

(73) Assignee: MOTOROLA, INC., Schaumburg, IL (US)

(21) Appl. No.: 11/967,541

(22) Filed: Dec. 31, 2007

(51) Int. Cl. H04Q 7/20

(52) U.S. Cl. 455/456.3

(57) ABSTRACT

A system and method for providing notification of a user's presence in a wireless keep-quiet geographic zone includes a fixed infrastructure device capable of conducting short-range wireless communication, and a server communicatively coupled to the fixed infrastructure device, accessible to a calling party, and including a phone book, wherein the fixed infrastructure device is operable to detect a presence of a wireless device within a wireless geographic keep-quiet zone, query the device for alternate contact information, aid update the phone book, accessible to a calling party, with an indication of the wireless device's presence in the wireless geographic zone and/or the alternate contact information.

### FIELD OF THE INVENTION

This invention relates in general to wireless keep-quiet zones, and more particularly, to providing availability status and alternate contact information pertaining to a user within a wireless keep-quiet zone.

### BACKGROUND OF THE INVENTION

In certain environments, it is necessary to protect electronic equipment from interference from signals generated by cellular wide area network (WAN) communication activity. Examples of these environments are hospitals and physician's offices, where some medical equipment can suffer from performance or reliability degradation in the presence of RF emissions. Other examples are high-security government and corporate research locations, electronic testing facilities, and airplanes, just to name a few. These areas where cellular radio communication activity is prohibited are commonly referred to as “wireless keep out zones.”

Although wireless radio communication activity is prohibited in these wireless keep out zones, other means of communication, such as land lines, email, instant messaging (IM), and others, may still be available. Currently, when a user enters a wireless keep out zone, however, his phone is disabled and anyone trying to reach that person must personally know the other communication methods to reach that person or be satisfied with leaving a message and waiting for a return call once the recipient of the call exits the zone.

Even if the caller does know other methods of reaching the recipient within the wireless keep out zone, they do not know which form of communication (email, land line. IM) the recipient within the zone prefers and/or will be checking first. Therefore, a need exists to overcome the problems with the prior art as discussed above.

### SUMMARY OF THE INVENTION

A system for providing notification of a user's presence in a wireless geographic zone, in accordance with an embodiment of the present invention, includes a fixed infrastructure device capable of conducting short-range wireless communication, the fixed infrastructure device being at least part of an instant-messaging system, and a server communicatively coupled to the fixed infrastructure device, accessible to a calling party, aid including a phone book. The fixed infrastructure device is operable to detect a presence of a wireless device within a wireless geographic zone, query the device for alternate contact information, and update the phone book, accessible to a calling party, with at least one of an indication of the wireless device's presence in the wireless geographic zone and the alternate contact information.

In accordance with another feature of the present invention, the querying is performed over a short-range wireless communication channel.

In accordance with a yet another feature, the present invention includes receiving instant-messaging credentials associated with a user of the wireless device in response to the querying step.

In accordance with a further feature of the present invention, the alternate contact information includes a number associated with a telephone located within the wireless geographic zone and/or a number associated with a telephone located adjacent the wireless geographic zone.

In accordance with a yet a further feature of the present invention, the alternate contact information includes an identifier identifying the wireless geographic zone, an identifier indicating that the user of the wireless device is “not available”, and/or an email address.

In accordance with a further feature of the present invention, the wireless geographic zone is defined by a transmission range, geographic coordinates, and/or a wireless keep-quiet zone.

In accordance with another mode, the present invention includes a method for providing notification of a user's presence in a wireless geographic zone, where the method includes the steps of entering a wireless geographic zone with a wireless device, receiving notification of a wireless keep-quiet restriction within the geographic zone, communicating instant messaging credentials associated with a user of the wireless device to a fixed infrastructure device over a short-range wireless communication channel, and communicating alternate contact information to the fixed infrastructure device.

Other features that are considered as characteristic for the invention are set forth in the appended claims.

Although the invention is illustrated and described herein as embodied in a device and system for providing availability status and alternate contact information pertaining a user within a wireless keep-quiet zone, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is art illustration of wireless devices communicating on a set of networks in accordance with an exemplary embodiment of the present invention;

FIG. 2 is a table illustrating a portion of the contents of a phone book in memory in accordance with an exemplary embodiment of the present invention;

FIG. 3 is an illustration of a wireless device moving from a cellular network to a wireless keep-quiet zone in accordance with an exemplary embodiment of the present invention;

FIG. 4 is a process flow diagram of a communication process of a wireless device's presence in a wireless keep-quiet zone and alternate contact information in accordance with an exemplary embodiment of the present invention;

FIG. 5 is a process How diagram of a communication process of a wireless device's presence in a wireless keep-quiet zone and a receipt of alternate contact information in accordance with an exemplary embodiment of the present invention;

FIG. 6 is a process flow diagram of a wireless device's departure from a wireless keep-quiet zone in accordance with an exemplary embodiment of the present invention; and

FIG. 7 is a simplified block diagram of a wireless communication device in accordance with an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

Embodiments herein can be implemented in a wide variety of ways using a variety of technologies that enable automatic communication of availability status and alternate contact information within a geographic area, i.e., a wireless keep-quiet zone. One embodiment of the present invention utilizes an Instant Messaging-like system (e.g., push to talk (PTT) over Cellular or other IP multimedia subsystem) that utilizes the notification from a short-range wireless link (access point) fixed to the location where the cellular communication is prohibited. A user's device, as they approach the short-range wireless link, will be informed of the restriction on wireless communication. At this time, the access point will communicate with the mobile device and gather information from the mobile device to update the mobile device's (i.e., user's) status within the system. The status of the user is given in appropriate terms so that others will be able to understand that the user is within a restricted communication zone, in addition, others will also receive a preferred alternate contact number or method for reaching the user while they remain within the restricted communication zone. For instance, the alternate number could be a land line to a switch-board operator, who has the ability to make an announcement within the zone that the user can bear. In one embodiment, the alternate contact number/method is supplied by the access point itself and either is given to the mobile device, so that it can submit a complete update to the IM server, or the access point delivers it directly to the 1M server on behalf of the user. Alternatively, the user can supply, through a keypad interface or other measures, an alternate phone number for return contact from the recipient in the wireless geographic area/keep-quiet zone. As an example, the user could provide the number of a nearby desk phone or pay phone during this time, in addition, the user or the access point can supply an email address, IM address, or other communication measures for reaching the recipient while in the wireless keep-quiet zone.

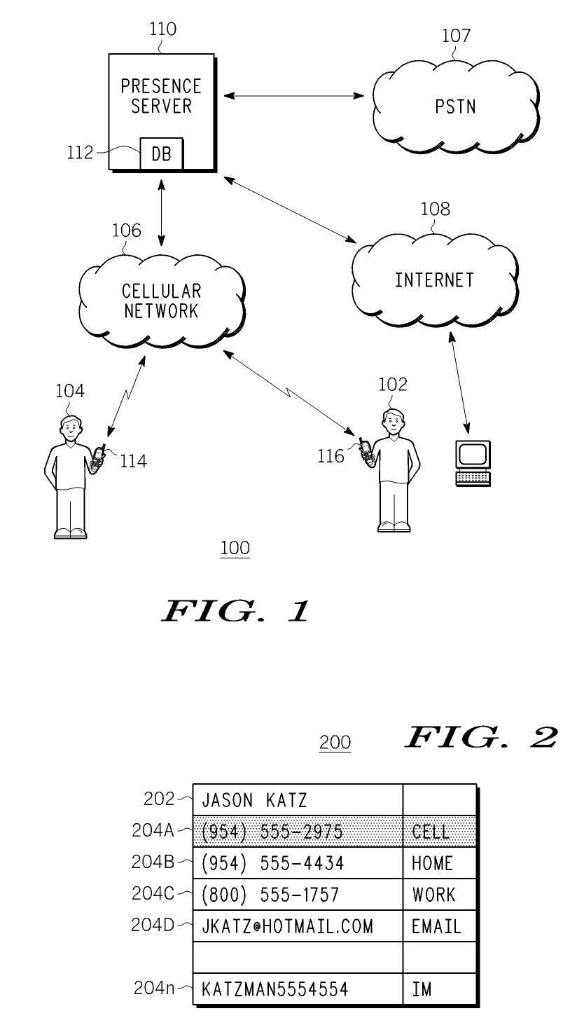

The following examples will be helpful in understanding the present invention. Turning now to FIG. 1, a communication system 100 for providing communication between a first party (the calling party) 102 and a second party (the called party or “recipient”) 104 is shown. The communication system includes a carrier network 106, a public switched telephone network (PSTN) 107, and the Internet 108. Carrier networks operate on cellular networks or Wide Area Networks (WAN) and are, generally, controlled by cellular carriers including, but not limited, to AT&T Wireless, Sprint PCS, Metro PCS, and Verizon Wireless. Carrier networks typically employ an analog-based air interface and/or one or more digital-based air interfaces. Digital-based air interfaces utilize digital communication technologies including, but not limited to, Code Division Multiple Access (CDMA), Time Division Multiple Access (TDMA), Global System for Mobile Communications (GSM), Wideband Code Division Multiple Access (WCDMA), Code Division Multiple Access-3rd Generation (CDMA2000), and the like.

In accordance with the present invention, the carrier network 106, PSTN 107, and the Internet 108 are connected to a presence server 110, which contains or is connected to a presence server database 112. The called party 104 communicates with a calling party 102 over any one or all of these networks via wireless devices 114 and 116, respectively.

The presence server 110 and presence server database 112 contain user subscription-related information (user profiles), perform authentication and authorization of the user, and can provide information about the called party's physical location. According to an exemplary embodiment of the present invention, the presence server database 112 stores and maintains one or more dynamic phonebooks accessible by the calling party 102 and containing contact information for the called party 104.

FIG. 2 shows a dynamic phone book 200 that is for example, contained within the presence server database 112. The phone book 200 identifies the called party 104 in a first field 202. Associated with the called party's name 202 are multiple entry areas 204a-n that each contain information helpful for reaching tire called party 104. For instance, as shown in FIG. 2, the phone book 200 has a field 204a containing the user's cellular phone number, a field 204b containing the user's home phone number, a field 204c containing the user's work phone number, a field 204d containing the user's email address, and a field 204n containing the user's IM screen name. A calling user 102 can, through the Internet 108 or cellular network 106, access the presence server 110 and retrieve information in the phone book 200 that will allow the calling party 102 to reach the called party 104. The dynamic phone book 200, however, does not necessarily belong to the called party 104, but instead, can belong to, and is accessible by, the calling party 102. The phone book 200 or a copy of the phone book can be contained in either the calling party's device 116 or the called party's device 114 and can be synchronized through or made accessible by the server 110. In other words, it is unimportant where the phone book 200 resides or how many copies of the book 200 exist.

In an embodiment of the present invention, the called party 104 is able to indicate which entry within in their particular phone book entry (e.g., FIG. 2) is the user's preferred contact method. For example, if somebody 102 wants to call the called party 104, he/she does not need to guess the location of the called party; the phone book will automatically communicate with the presence server 110 and obtain the current location and updated contact number or phone number. This process is described with the following example. When the calling party 102 presses send on the called party's name in their personal phone book (e.g., on their wireless device 116), the phone number pointed to by that phone book is the called party's actual cell phone number when the called party 104 is not within a keep-quiet zone. However, if the called party 104 is in the keep-quiet zone, the calling party's cellular phone contact list lists the number that the phone book 200 in the presence server points to, for instance, the called party's work desk number, home number, or local building operator, depending on the called party's particular preference.

To some calling parties, the user's current location/status can be kept private. The presence server 110 can allow the called party 104 to enter which particular calling party 102 can receive the forwarding information and what information can be shared with that calling party 102. All information can be transparent to the calling party 102 in a way that maintains privacy. The phone 116 can use contact information hidden from the calling party 102 so the calling party 102 does not have a way to know where the called party 104 is located unless the called, party 104 tells the system to reveal that information/location (by setting such preferences).

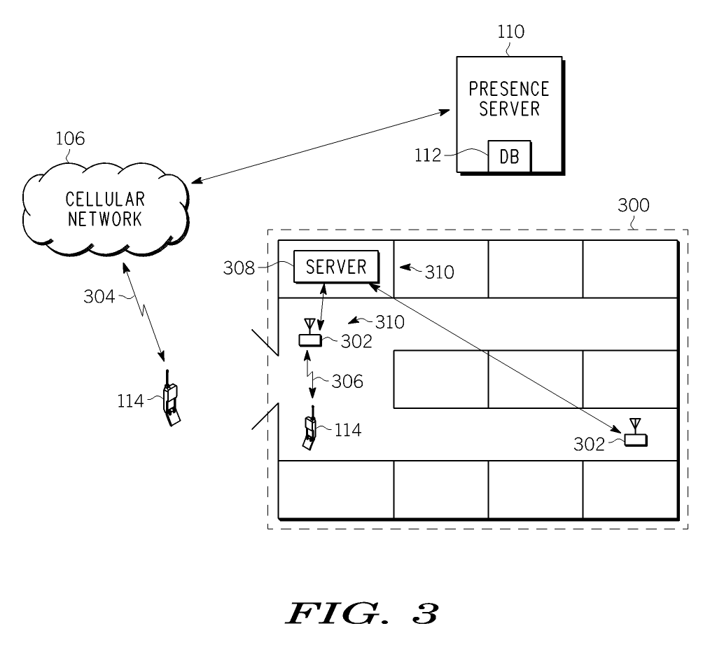

Referring now to FIG. 3, a geographic zone 300, represented as an exemplary office floor plan, is shown. In this embodiment, the geographic zone 300 is an area where cellular RF communication is banned or restricted. The zone can be defined by geographic coordinates, by a transmission range, or by a defined wireless keep-quiet zone. While outside the zone 300, the mobile device 114 is in direct cellular communication, via a link 304, with the carrier network 106. However, once the device 114 enters the geographic zone 300, RF communication with the carrier network 106 is no longer permitted. Although RF communication is prohibited inside the geographic zone 300, having no measures for communication is undesirable. Therefore, exemplary embodiments of the present invention provide multiple ways of providing alternate contact modes and corresponding alternate contact, information for the called party 104.

The area 300 includes one or more access points 302 that are part of a wireless local area network (WLAN) 310. The WLAN provides short range wireless links to wireless devices. WLANs are non-carrier networks and, generally, are not controlled by cellular carriers. WLANs employ an air interface including, but not limited to, IEEE 802.11, which is supported by the Institute of Electrical and Electronics Engineers, Inc., such as Wi-Fi supported by the Wireless Ethernet Compatibility Alliance, Bluetooth™ supported by the Bluetooth SIG, Inc., HomeRF supported, by the HomeRF Working Group Inc., and the like.

The communication units or devices 114 that operate within the carrier network 106 and WLAN 310 have wireless communication capabilities, such as IEEE 802.11, Bluetooth™, WiMax, Wi-Fi, or Hiper-Lan and the like that, preferably, utilize CDMA, frequency hopping, OFDM or TDMA access technologies and one or more of various networking protocols, such as TCP/IP (Transmission Control Protocol/Internet Protocol), UDP/IP (User Datagram Protocol/IP), IPX/SPX (Inter-Packet Exchange/Sequential Packet Exchange), Net BIOS (Network Basic Input Output System) or other protocol structures.

Once inside the wireless geographic zone 300, the device 114 utilizes an instant-messaging-like system, i.e., push to talk over cellular or other IP multimedia system (IMS), to communicate with the access point(s) 302 over a short-range wireless link 306, The IMS is an architectural framework for delivering Internet protocol (IP) multimedia to mobile users. It is defined by the Open Mobile Alliance (OMA), which is a standards body that develops open standards for the mobile phone industry. IMS, as far as possible, uses IETF (i.e., internet) protocols such as Session Initiation Protocol (SIP) to aid the access of multimedia and voice applications across wireless and wire line terminals.

A user can connect to an IMS network in various ways, all of which use standard IP. Direct IMS terminals (such as mobile phones, personal digital assistants (PDAs), and computers) can register directly on an IMS network, even when they are roaming in another network. To do this, they simply run SIP user agents. Fixed access (e.g., Digital Subscriber Line (DSL), cable modems, Ethernet), mobile access (e.g. W-CDMA, CDMA2000, GSM, GPRS), and wireless access (e.g., WLAN, Wi-Fi, WiMAX) are all supported. Other phone systems like plain old telephone service (POTS—the old analog telephones), H.323, and non IMS-compatible voice over IP (VoIP) systems are supported through gateways.

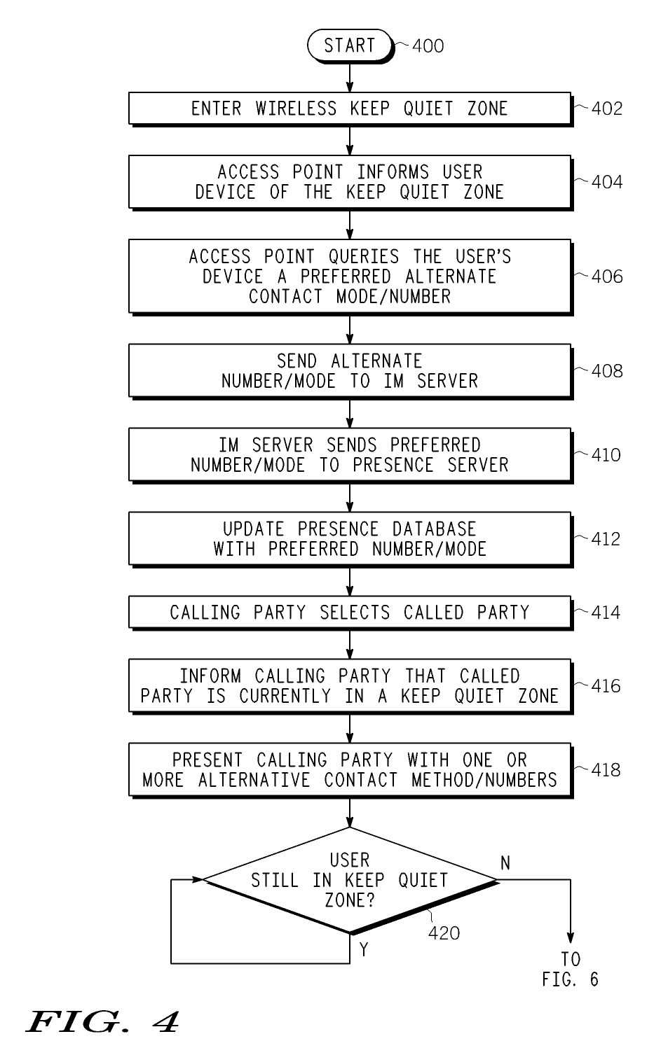

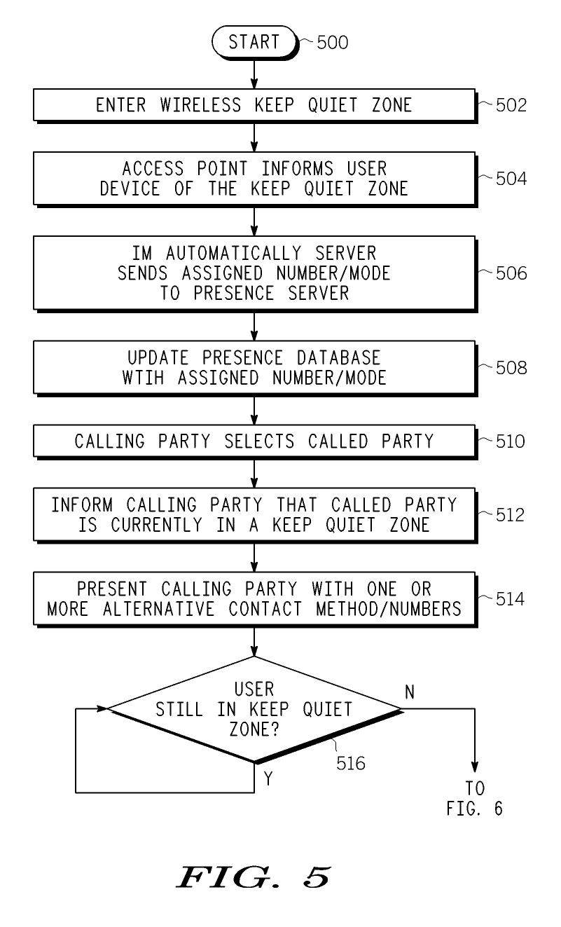

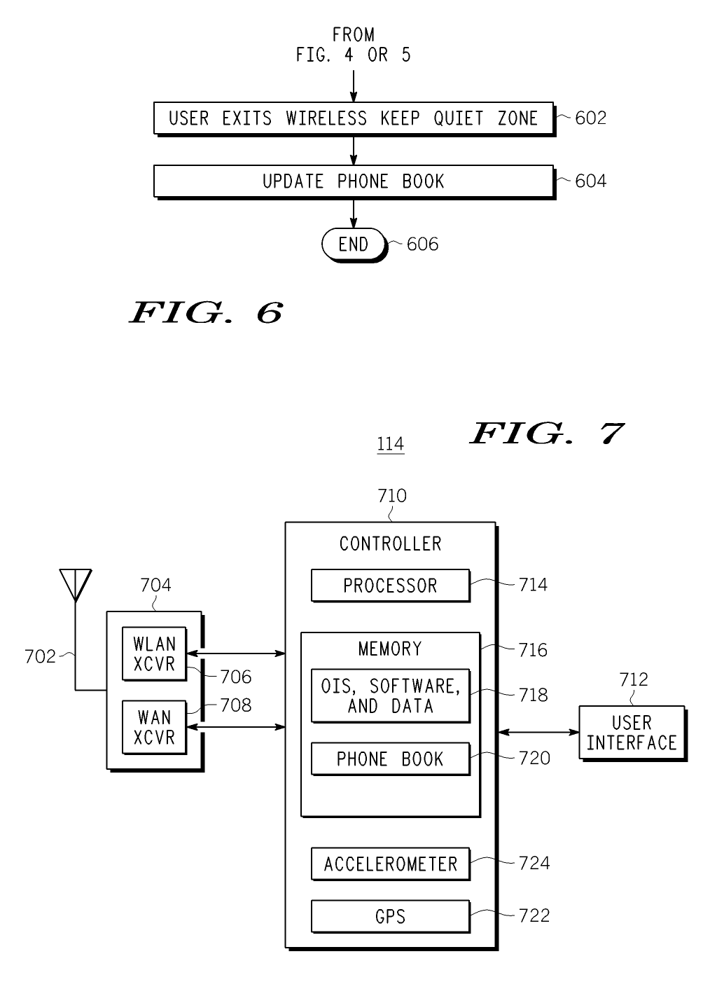

In a first embodiment of the present invention, as shown in FIG. 3 and explained in the flow chart of FIG. 4, the flow begins at step 400 and moves to step 402 where a user device 114 moves within range of one of the access point(s) 302. In step 404, the access point(s) 302 informs the user's device 114 of the keep-quiet zone 300. At this time, in step 406, the access point 302 queries the user 104 and/or the user's device 114 for a preferred alternate contact mode/number. In one embodiment, this number/mode is a selection made by the user 104 at the time of query. In another embodiment, this number/mode is pre-programmed into the device 114 and is automatically sent by the user's device 114 to the access point(s) 302. Other ways of selecting an alternate contact number are described below. In step 408, the alternate number/mode is sent to an IM server 308, which controls the access point(s) 302. In step 410, the IM server 308 communicates the updated preferred number/mode for communication to the presence server 110. The IM server 308 updates the presence database 112 with the new information in step 412, making the new information available for access by the calling party 102, In step 414, the calling party 102 selects the called party 104 in his/her personal phone book and, in step 416, is informed that the called party is currently in a keep-quiet zone 300. The calling party 102 is then, presented with one or more alternative contact method/numbers in step 418, which the calling party 102 can select, or wait until, the called party leaves the keep-quiet zone 300. Alternatively, the calling party 102 can be given no information or information that, the called party 104 does not wish to be disturbed. The process then waits, in step 420, until the device leaves the keep quite zone 300.

The present invention could be implemented, for example, in a situation where the called party 102 enters a hospital that maintains a wireless keep-quiet zone. The user 102 may respond to a prompt provided by the access point(s) 302 by providing a phone number that for example, can be used to reach the front desk of the hospital. If the calling party 102 were to try and call the called party 104, the calling party 102 would be given, for instance, the number to the front desk of the hospital and the called party 104 could be reached in that way. Similarly, the called party 104 could pre-define his keep-quiet-zone response by setting priorities in his own phone book. Once his mobile device 114 receives notification that it is in a keep-quiet-zone 300, the device 114 will move to the next highest priority contact method/number in the phone book 200 and provide this information to the access point(s) 302.

FIG. 5 show's a process flow of another embodiment of the present invention. The flow begins at step 500 and moves to step 502 where a user device 114 moves within range of one of the access point(s) 302. In step 504, the access point(s) 302 informs the user's device 114 of the keep-quiet zone 300. In this embodiment, the access point(s) 302, through the 1M server 308, in step 506, informs the presence server 110 of the called, user's presence in the keep-quiet zone 300 and automatically updates the called party's phone book 200, in step 508, with the alternate contact information, i.e., email address. IM address, phone number, or others. This embodiment makes updating, the phonebook 200 automatic and possibly invisible to the users 102 of the mobile device 114.

The contact information, in one exemplary embodiment, is a number that is assigned individually to each device that enters the zone 300. Thereafter, the new information is available for access by the calling party 102. In step 510, the calling party 102 selects the called party 104 in his personal phone book and, in step 512, is informed that the called party 104 is currently in a keep-quiet zone 300. This information can he indicated by a message, by graying out the user's cellular number, by making the number non-selectable, or by other measures. The calling party 102 is, then, presented with one or more alternative contact measures/numbers in step 514, which the calling party 102 can select, or wait until the called party 104 leaves the keep-quiet zone 300. The process then waits, in step 516, until the device 114 leaves the keep quite zone 300.

FIG. 6 shows a process flow diagram indicating the steps taken when a called party 102 leaves the geographic zone 300. The process begins at step 602, where the called patty 102 exits the zone 300. Any of the methods explained above can be used for determining the departure from the zone 300. The device 114 can, then, initiate, in step 604, an update of the phone book 200 so that the calling party 102 is no longer told that that the called party 104 is in the wireless keep-quiet zone 300 In this update, the phone book 200 can be reset back to the state that it was in prior to the entry of the called party 102 and his/her device 114 into the wireless keep-quiet zone 300 or, alternatively, the called party 102 can cause a new communication measure/number to be displayed as the preferred contact measure/number, either by manual input, or by pre-selected device responses. The flow ends at step 606.

Referring now to FIG. 7, a simplified block diagram of a wireless communication unit 114 that is capable of operating between the carrier network 106 and WLAN 310 is discussed and described. The mobile device 114 is generally known, thus the known functions and structure of such devices will not be described in detail other than as related to tire inventive principles and concepts disclosed and discussed below. The mobile device 114 includes an antenna 702 or antenna structure that operates to couple radio frequency signals between a transceiver 704 and the carrier network 106 and WLAN 310. For example, radio signals that are transmitted from the carrier network 106 or WLAN 310, such as respectively, by the carrier network 106 base stations or the access points (WLAN transceiver) 302 are absorbed by the antenna 702 and coupled to a receiver, that is part of the transceiver 704.

Respectively, signals that are amplified by and coupled from the transceiver 704, specifically a transmitter (WLAN transmitter or WAN transmitter), to the antenna 702 are radiated or transmitted or sent to the access point or base station according to known WLAN technologies, such as 802.11 and others earlier mentioned or WAN technologies, such as known cellular networks. The transceiver 704 will be configurable to support simultaneous air interfaces with multiple communication networks according to the conventions and protocols of each or may, alternatively, further include one or more of a WLAN transceiver 706 and WAN transceiver 708 for such purposes as will be appreciated by those of ordinary skill. The transceiver 704 or respective receivers and transmitters are inter-coupled as depicted and interactively operate with and are controlled by a controller 710 to provide to, accept from, or receive from the controller 710 voice traffic or data messages or signals corresponding thereto in packet data form.

Accordingly, the transceiver 704, as controlled by, and in cooperation with, the controller 710 and functions thereof, provide the mobile device 114 with multi- or dual-operating mode capability. More particularly, the mobile device 114 is capable of registering with and obtaining service from the carrier network 106 and WLAN 310.

The controller 710 is coupled to and generally operates in a known manner with a user interface 712. The user interface 712 is known and typically includes, for example, audio transducers, such as an earphone or speaker and microphone, a display, and a keypad. The transceiver 704 and user interface 712 are each inter-coupled and the controller 710 provides overall operational command and control for the mobile device 114.

The controller 710 is substantially a general-purpose processor and, preferably, includes a processor 714 and an associated memory 716. The processor 714 is, preferably, a known processor-based element with functionality that will depend on the specifics of the air interfaces with the first and tire second network as well as various network protocols for voice and data traffic. The processor 714 will operate to encode and decode voice and data messages to provide signals suitable for the transceiver 704, a transducer, or further processing by the controller 710. The processor 714 may include one or more generally available microprocessors, digital signal processors, and other integrated circuits depending on the responsibilities of the controller 710 with respect to signal processing duties or other unit features that are not here relevant.

In any event, the controller 710 also includes the memory 716 that may be, for example, a combination of known RAM (Random Access Memory), ROM (Read-Only Memory), EEPROM (Electrically Erasable Programmable ROM) or magnetic memory. The memory 716 is used to store, among various other items or programs etc, an operating system or software and data 718, such as a caller list, for execution or use by the processor 714. This operating software 718, when executed by the processor 714, will result in the processor performing the requisite functions of the mobile device 114, such as interfacing with the user interface 712 and transceiver 704 or transmitting and receiving devices.

The memory 716 further includes call-processing routines not specifically shown for supporting voice and data calls that will be appreciated by one of ordinary skill and that will vary depending on air interface, call processing, and service provider or network specifics.

A further memory location 720 is used to store device, system, or user specified information. One example of such information is the phone book 200 used to facilitate communication to other devices 116 within the network or within other networks to which the originating device is not a member. The phone book 200 can also be stored in other locations or other memories that are a part of the wireless device 114 or, as stated above, are external to the wireless device 114.

In other embodiment of the present invention, instead of only being alerted of the keep-quiet zone 300 by the access point(s) 202, or in lieu of being alerted of the keep-quiet zone 300 by the access point(s) 202, the device 114 can be equipped with a global positioning system (GPS) sensor 722, as shown in FIG. 7, which communicates with the memory 716 that contains coordinates of keep quiet zones. When the device's current coordinates intersect with predefined coordinates of a keep-quiet zone 300, the device automatically ceases WAN communication and updates the phone book 200 indicating the user's presence in the zone 300 and an alternate number/method of reaching the user 104.

All of the above-described ways of identifying the device's entry into a keep-quiet zone 300 can also be used to identify a device's departure from the keep-quiet zone 300. More specifically, the device can monitor the GPS unit 722 and reinitiate communication with the cellular network 106 once the device's actual coordinates no longer intersect with the defined coordinates of the keep-quiet zone 300. Alternatively, once the device 114 is no longer receiving signals from the access point(s) 302, the device 114 can assume that it is no longer in the keep-quiet zone 300 and that it is allowed to resume communication with the cellular network 106. In one embodiment, the device 114 is equipped with an accelerometer 724. The accelerometer 724, once activated, can be monitored. After a pre-selected period of time that the accelerometer 724 is activated, it can be assumed that the device 114 is at a sufficient distance from the zone 300 that it can resume communication with the cellular network 106. At this time, it can resume communication with the cellular network 106 or can confirm, by communicating with that access point(s) 302 for instance, via Wi-Fi, that it is in fact out of the keep-quiet zone 300.

### CONCLUSION

As should now be clear, the present invention provides, within an Instant Messaging System, a fixed infrastructure device (access points) utilizing short-range wireless communication to a mobile device also having short range wireless communications belonging to a user. The communication involves the exchange of the user's Instant Messaging credentials to change the status of the user to “unavailable due to Transmit Keep out Zone”. In addition, is the ability of the fixed infrastructure to provide an alternate land line phone number for alternate communication means in case of emergency within the instant messaging-like system.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any aid all such applications, modifications, and embodiments within the scope of the present invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically,

What is claimed is:

1. A method for providing notification of a user's presence in a wireless geographic zone, the method comprising;
detecting, with a fixed infrastructure device in an instant-messaging system, a presence of a wireless device within a geographic zone:
querying the device for alternate contact information; and
updating a phone book, accessible to a calling party, with:
an indication of the wireless device's presence in the wireless geographic zone: and
the alternate contact information.

2. The method according to claim 1, wherein:
the querying is performed over a short-range wireless communication channel.

3. The method according to claim 1, further comprising;
receiving instant-messaging credentials associated with a user of the wireless device in response to the querying step.

4. The method according to claim 1, wherein the alternate contact information is at least one of:
a number associated with a telephone located within the wireless geographic zone: and
a number associated with a telephone located adjacent the wireless geographic zone.

5. The method according to claim 1, wherein the alternate contact information is at least one of:
an identifier identifying the wireless geographic zone:
an identifier indicating that the user of the wireless device is “not available”: and
an email address.

6. The method according to claim 1, wherein:
the fixed infrastructure device is an access point.

7. The method according to claim 1, wherein:
the wireless geographic zone is defined by one of;
a transmission range;
geographic coordinates: and
a wireless keep-quiet zone.

8. A system for providing notification of a user's presence in a wireless geographic zone, the system comprising:
a fixed infrastructure device capable of conducting short-range wireless communication, the fixed infrastructure device being at least part of an instant-messaging system; and
a server communicatively coupled to the fixed infrastructure device, accessible to a calling party, and including a phone book,
wherein the fixed infrastructure device is operable to:
detect a presence of a wireless device within a wireless geographic zone;
query the device for alternate contact information; and
update the phone book, accessible to a calling party, with at least one of:
an indication of the wireless device's presence in the wireless geographic zone; and
the alternate contact information.

9. The system according to claim 8, wherein the fixed infrastructure device is further operable to:
querying the device for alternate contact information over a short-range wireless communication channel.

10. The system according to claim 8, wherein the fixed infrastructure device is further operable to:
receive instant-messaging credentials associated with a user of the wireless device in response to querying the device for alternate contact information.

11. The system according to claim 8, wherein the alternate contact, information is at least one of;
a number associated with a telephone located within the wireless geographic zone: and
a number associated with a telephone located adjacent the wireless geographic zone.

12. The system according to claim 8, wherein the alternate contact information is at least one of;
an identifier identifying the wireless geographic zone;
an identifier indicating that the user of the wireless device is “not available”: and
an email address.

13. The system according to claim 8, wherein:
the fixed infrastructure device is an access point.

14. The system according to claim 8, wherein:
the wireless geographic zone is defined by one of:
a transmission range;
geographic coordinates; and
a wireless keep-quiet zone.

15. A method for providing notification of a user's presence in a wireless geographic zone, the method comprising;
entering a wireless geographic zone with a wireless device;
receiving notification of a wireless keep-quiet restriction within the geographic zone;
communicating instant messaging credentials associated with a user of the wireless device to a fixed infrastructure device over a short-range wireless communication channel: and
communicating alternate contact information to the fixed infrastructure device.

16. The method according to claim 15, further comprising;
communicating the instant messaging credentials over a short-range wireless communication channel.

17. The method according to claim 15, wherein the alternate contact information is at least one of:
a number associated with a communication device located within the wireless geographic zone; and
a number associated with a communication device located adjacent the wireless geographic zone.

18. The method according to claim 15, wherein the alternate contact information is at least one of:
an identifier identifying the wireless geographic zone;
an identifier indicating that the user of the wireless device is “not available”; and
an email address.

19. The method according to claim 15, wherein:
the fixed infrastructure device is an access point.

20. The method according to claim 15, wherein:
the wireless geographic zone is defined by one of:
a transmission range;
geographic coordinates; and
a wireless keep-quiet zone.
